(19) United States
(12) Patent Application Publication
(10) Pub. No.: US 2009/0103143 A1
(43) Pub. Date: Apr. 23, 2009

(54) IMAGE READING APPARATUS AND IMAGE FORMING APPARATUS

(75) Inventor: Masaki Baba, Osaka-shi (JP)

Correspondence Address: CASELLA & HESPOS, 274 MADISON AVENUE, NEW YORK, NY, 10016, US

(73) Assignee: KYOCERA MITA CORPORATION, Osaka-shi (JP)

(21) Appl. No.: 12/251,547

(22) Filed: Oct. 15, 2008

(30) Foreign Application Priority Data
Oct. 17, 2007 (JP) 2007-270211

(51) Int. Cl. H04N 1/40; G06K 9/36

(52) U.S. Cl. 358/448; 382/232

(57) ABSTRACT

An image reading apparatus has a document reader for reading an image from a document and generating image data. A determining section determines whether the read document is color or monochromatic. An area separator separates a character area in the image data generated by the document reader and generates area information indicating the separated character area. A character document determining portion determines whether the document is a character document in accordance with the area information. A compressing portion compresses the image data generated by the document reader into a first compression format if the document is determined to be a monochromatic character document, or into a second compression format if the document is determined to be a monochromatic document that is not a character document. A storage section stores the image data compressed by the compressing portion.

### BACKGROUND OF THE INVENTION

1. Field of the Invention

The present invention relates to an image reading apparatus for reading an image from a document, and an image forming apparatus for forming an image which is read by the image reading apparatus onto a sheet.

2. Description of the Related Art

Conventionally, for the purpose of improving added value and practicality by printing in accordance with colors of a document, there have been known an image forming apparatus which is capable of performing both a color image printing of superimposing and transferring toner images of four colors e.g. cyan (C), magenta (M), yellow (Y), and black (K) with respect to a color document, and a monochromatic image printing of transferring a toner image of only one color e.g. black with respect to a monochromatic document.

Selective execution of the color image printing and the monochromatic image printing is realized by an ACS (Auto Color Select) processing function of automatically determining if an image on a document is a monochromatic image or a color image. In such image forming apparatus, image data of RGB colors read by an image reading apparatus such as a color scanner is temporarily taken into an image memory, and the image data is guided to an ACS processing circuit so that it is discriminated whether the image on the document is a monochromatic image or a color image.

Then, an image conversion processing is performed with respect to the image data stored in the image memory in accordance with the determination result of the ACS processing circuit (for example, refer to Japanese Patent Unexamined Publication No. 2004-297609).

Meanwhile, the image conversion processing which is performed in accordance with the discrimination result of the ACS processing circuit as described above includes a compression processing with respect to image data. A data compression format which is suitable for an image is selected in accordance with the determination result of the ACS processing circuit. As data compression formats, there have been known various compression formats such as a JBIG (Joint Bi-lebel Image experts Group: ITU-T T.82 ISO/IEC 11544), which is a compression format for a two-valued image, a JPEG(Joint Photographic Expert Group), which is a compression format for a multi-valued image, and the like.

However, in the case where a data compression format is selected in accordance with a discrimination result of the ACS processing circuit as described above, there may be a case where a compression format which is suitable for image data is not selected necessarily.

### SUMMARY OF THE INVENTION

The present invention was made in view of such situation, and its object is to provide an image reading apparatus, which is capable of determining if a document image is color or monochromatic and compressing the image data in a compression format suitable for a document image, and an image forming apparatus.

An image reading apparatus in accordance with an aspect of the present invention includes: a document reading section for reading an image from a document and generating image data indicating the read image; a determining section for determining that the document is a color document or a monochromatic document in accordance with the image data generated by the document reading section; an area separating portion for separating a character area in the image data generated by the document reading section, and generating area information indicating the separated character area; a character document determining portion for determining whether or not the document is a character document in accordance with the area information generated by the area separating portion; a compressing portion for compressing the image data generated by the document reading section into a first compression format which is a compression format for a two-valued image in a case where the determining section determines that the document is a monochromatic document and the character document determining portion determines that the document is a character document, the compressing portion compressing the image data generated by the document reading section into a second compression format for multiple-valued image in a case where the determining section determines that the document is a monochromatic document, and the character document determining portion determines that the document is not a character document; and a storage section for storing the image data compressed by the compressing portion.

According to this configuration, the document reading section reads an image from a document and generates image data indicating the read image. Further, the determining section determines if the document is a color document or a monochromatic document in accordance with the image data generated by the document reading section. Then, the area separating portion separates a character area in the image data generated by the document reading section, and generates area information indicating the separated character area. Further, the character document determining portion determines whether or not the document is a character document in accordance with the area information generated by the area separating portion. Further, in a case where the determining section determines that the document is a monochromatic document and the character document determining portion determines that the document is a character document, the compressing portion compresses the image data generated by the document reading section into the first compression format which is a compression format for a two-valued image. On the other hand, in a case where the determining section determines that the document is a monochromatic document, and the character document determining portion determines that the document is not a character document, the compressing portion compresses the image data generated by the document reading section into a second compression format for multiple-valued image. Then, the storage section stores the image data compressed by the compressing portion.

Accordingly, determination that a document image is color or monochromatic is performed, and the image data can be compressed into a compression format which is suitable for a document image.

Further, an image forming apparatus in accordance with an aspect of the present invention includes: the above-described image reading apparatus and an image forming section for forming an image onto a sheet in accordance with the compressed image data stored in the storage section.

According to this configuration, in the image forming apparatus, the determination that the document image is color or monochromatic is performed, and the image data for use in the image forming can be compressed in a compression format which is suitable for the document image. Accordingly, it becomes easy to reduce the capacity of the storage section.

The image reading apparatus and the image forming apparatus having such configuration performs determination on that the document image is color or monochromatic, and image data can be compressed into a compression format which is suitable for a document image.

These and other objects, features and advantages of the present invention will become more apparent upon reading of the following detailed description along with the accompanied drawings.

### BRIEF DESCRIPTION OF DRAWINGS

FIG. 1 is a block diagram showing an example of a configuration of an image forming apparatus in accordance with an embodiment of the present invention.

FIG. 2 is a flowchart showing an example of an operation of the image forming apparatus shown in FIG. 1.

FIG. 3 is a flowchart showing an example of an operation of the image forming apparatus shown in FIG. 1.

FIG. 4 shows an example of a document image read by the scanner section shown in FIG. 1.

FIG. 5 shows an example of area information generated by the area separating portion shown in FIG. 1.

FIG. 6 shows an operation of the area information reducing portion shown in FIG. 1.

FIG. 7 shows an operation of the area information reducing portion shown in FIG. 1.

### DETAILED DESCRIPTION OF THE PREFERRED EMBODIMENTS

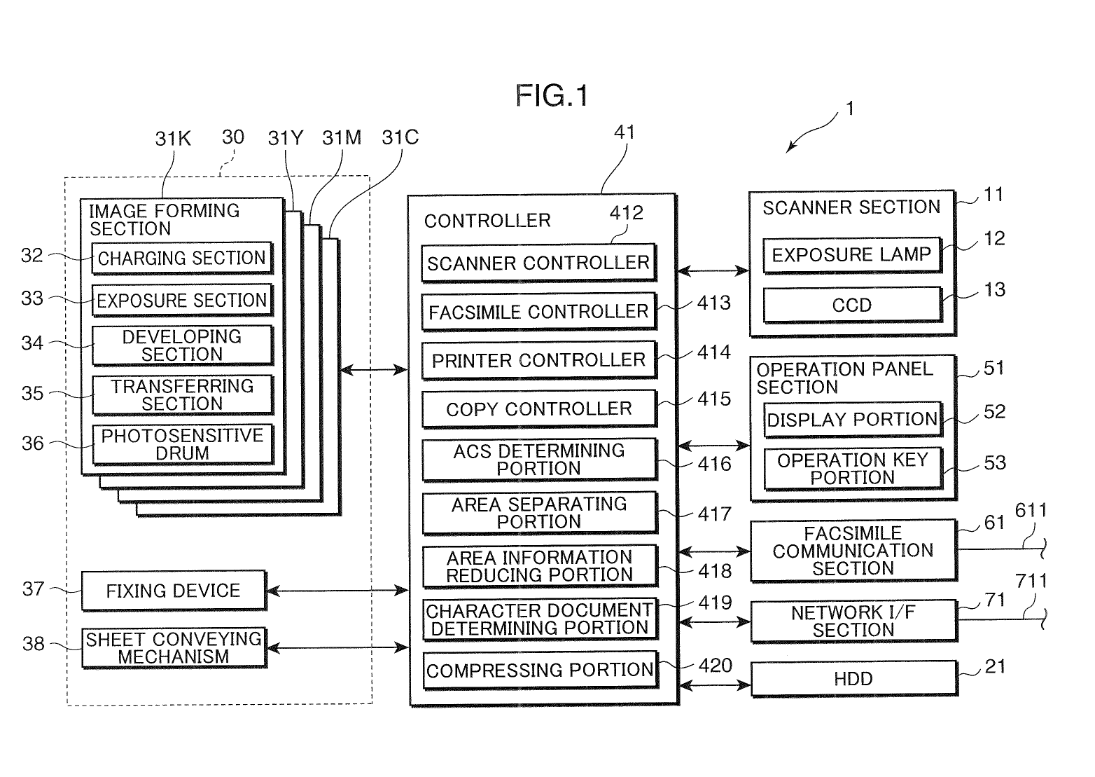

Hereinafter, an embodiment of the present invention will be described with reference to the drawings. Configurations which are indicated by the same reference signs in the drawings indicate that those have the same configurations, and description regarding those will be omitted. FIG. 1 is a block diagram showing an example of a configuration of an image forming apparatus in accordance with an embodiment of the present invention. The image forming apparatus 1 shown in FIG. 1 is a complex machine having a plurality of functions related to image forming, such as a copying function, a printer function, a facsimile function, a scanner function, and the like.

The image forming apparatus 1 includes a scanner section 11 (document reading section), an HDD (Hard Disk Drive) 21 (storage section), a printer section 30 (image forming section), a controller 41, an operation panel section 51, a facsimile communication section 61, and a network I/F section 71. The storage section maybe a semiconductor memory.

An example of the image forming apparatus is configured with the scanner section 11, the HDD 21, the controller 41, the operation panel section 51, and the network I/F section 71. This configuration realizes functions such as a network scanner function of sending the taken image data as an electronic mail to a terminal device having a designated e-mail address or sending the image data directly to an IP address of the terminal device, and a scanner function of sending image data to a terminal device connected to an unillustrated interface circuit.

Further, the scanner section 11, the HDD 21, the printer section 30, the controller 41, the operation panel section 51, and the facsimile communication section 61 realize the facsimile function. Further, the HDD 21, the printer section 30, the controller 41, the operation panel section 51, and the network I/F section 71 realize the printer function. Further, the scanner section 11, the HDD 21, the printer section 30, the controller 41, and the operation panel section 51 realize the copying function.

The operation panel section 51 is used for allowing a user to perform operations related to the copying function, the printer function, the facsimile function, the scanner function, and the like. The operation panel section 51 gives an operation instruction by a user, for example, printing of information stored in the HDD 21 to the controller 41. The operation panel section 51 includes a display portion 52 having a touch panel and the like, an operation key portion 53 having a start key and numerical keys, and the like.

The display portion 52 has a displayable touch panel unit which is a combination of the touch panel and the LCD (Liquid Crystal Display). The display portion 52 displays various operation screens and enables input operations. The display portion 52, for example, at a time of executing the facsimile function, displays information related to a user selection, an addressee selection, a transmission setting, and the like, and has operation buttons which are to be touched by a user for input of various operation instructions. The operation key portion 53 is used for input of various instructions such as a copy execution start instruction or a facsimile transmission start instruction by a user.

The scanner section 11 acquires a document image optically and generates image data. The scanner section 11 includes an exposure lamp 12 and a CCD (Charge Coupled Device) 13. In the scanner section 11, the exposure lamp 12 irradiates a light to a document, and the CCD 13 receives a reflected light, so that a document image is read, and image data corresponding to the read image is outputted to the controller 41. In the scanner section 11, not only a monochromatic document, but also a color document and a picture document can be read.

The HDD 21 is a storage device which stores various data such as document image data compressed by a compressing portion 420 which will be described hereinafter.

The printer section 30 is an image forming section of so-called electrophotographic type. The printer section 30 prints an image onto a predetermined sheet in accordance with image data such as image data of a document read by the scanner section 11, image data received from an external personal computer through the network I/F section 71, and image data such as facsimile data received from an external facsimile machine through the facsimile communication section 61.

The printer section 30 includes image forming sections 31K, 31Y, 31M, and 31C, a fixing device 37, and a sheet conveying mechanism 38. The image forming sections 31K, 31Y, 31M, and 31C form images of black, yellow, magenta, and cyan, respectively. Each of the image forming sections 31K, 31Y, 31M, and 31C includes a charging section 32, an exposure section 33, a developing section 34, a transferring section 35, and a photoconductive drum 36.

The charging section 32 charges a surface of the photoconductive drum 36. The exposure section 33 allows the surface of the photoconductive drum 36 to be charged in accordance with image data of a respective color, so that an electrostatic latent image is formed on the surface of the photoconductive drum 36. The developing section 34 develops the electrostatic latent image on the photoconductive drum 36 with toners of a respective color. The transferring sections 35 of the image forming sections 31K, 31Y, 31M, and 31C superimpose and transfer toner images of respective colors formed on the surfaces of the photoconductive drums 36. Accordingly, a color toner image is formed on a sheet.

The fixing device 37 drives a pair of fixing rollers including a heat roller and a pressure roller so as to press and fix the toner image transferred on the sheet. The sheet conveying mechanism 38 includes, for example, a sheet feeding cassette, a sheet conveying roller, and the like, and conveys a sheet for image forming and sheet discharging.

The printer section 30 is not limited to the electrophotographic type of forming an image with toners. For example, various types including an ink-jet type of forming an image by discharging ink to a sheet, a heat-transfer type of transferring an image onto a sheet by heating an ink film, and the like may be also adopted.

The facsimile communication section 61 includes an encoding/decoding section (not illustrated), a modulating/demodulating section (not illustrated), and an NCU (Network Control Unit) (not illustrated). The facsimile communication section 61 sends image data of the document read by the scanner section 11 to another facsimile machine or receives image data sent from another facsimile machine through a communication line 611 such as a phone line and an internet line.

The encoding/decoding section compresses/encodes image data to be sent, and expands/decodes received image data. The modulating/demodulating section modulates the compressed/encoded image data into an audio signal or demodulates a received signal (audio signal) into image data. Further, the NCU controls connection through a phone line with respect to a facsimile machine, which is an addressee.

The network I/F section 71 uses a network interface (for example, 10/100 base-TX) to control various data transmission with respect to an unillustrated terminal device which is connected through a network 711. For example, the network I/F section 71 sends document image data, which is read by the scanner section 11 and compressed by the compressing portion 420 to be a compression format such as JPEG, JBIG, MMR (Modified Modified Relative Element Address Designate: ITU-T T.6) or the like which will be described hereinafter, to an unillustrated device as an electronic mail. Further, the network I/F section 71 receives image data sent from an unillustrated terminal device through the network 711 for printing in the printer section 30.

A terminal device to be connected to the network I/F section 71 or to an unillustrated interface circuit may be, for example, a personal computer, another image forming apparatus, or another information processing apparatus.

The controller 41 is provided with, for example, a CPU (Central Processing Unit) which executes a predetermined arithmetic calculation processing, a nonvolatile ROM (Read Only Memory) which stores a predetermined control program, a RAM (Random Access Memory) which temporarily stores data, a peripheral circuit, and the like. Accordingly, the controller 41 can totally control the image forming apparatus 1 in accordance with instruction information received by the operation panel section 51 and detection signals transmitted from sensors provided at respective portions of the image forming apparatus 1.

The controller 41 executes a control program stored in, for example, the ROM to serve as a scanner controller 412, a facsimile controller 413, a printer controller 414, a copy controller 415, an ACS determining portion 416 (determining portion), an area separating portion 417, an area information reducing portion 418, a character document determining portion 419, and a compressing portion 420. Further, the ACS determining portion 416, the area separating portion 417, the area information reducing portion 418, the character document determining portion 419, and the compressing portion 420 may be configured by using a dedicated circuit such as an ASIC (Application Specific Integrated Circuit) or the like.

The scanner controller 412 controls operations of respective portions which are used for realizing the scanner function. In particular, for example, when a scanning start instruction is received by the operation panel section 51, the scanner controller 412 allows the scanner section 11 to read a document image. Then, the scanner controller 412 allows the compressing portion 420 to compress image data indicating the document image generated by the scanner section 11 to generate compressed image data.

Further, for example, when an instruction of sending image data is received by the operation panel section 51, the scanner controller 412 controls the network I/F section 71 to send compressed image data stored in the HDD 21 to an unillustrated terminal device through the network 711.

The facsimile controller 413 controls operations of respective parts used for realizing the facsimile function. The facsimile controller 413, when a facsimile transmission is performed, controls the facsimile communication section 61 to designate telephone numbers stored in the HDD 21 and directly send image data of a document read by the scanner section 11 through a communication line 611. The printer controller 414 controls operations of respective parts used for realizing the printer function.

The copy controller 415 controls operations of respective parts used for realizing the copying function. In particular, for example, when the operation panel section 51 receives a copy starting instruction, the copy controller 415 controls the scanner section 11 to read a document image. Then, the copy controller 415 controls the compressing portion 420 to compress the image data showing the document image generated by the scanner section 11 to generate compressed image data.

Further, the copy controller 415 stores the compressed image data generated by the compressing portion 420 into the HDD 21. Then, the copy controller 415 controls the printer section 30 to form an image onto a sheet in accordance with the compressed image data stored in the HDD 21.

The ACS determining portion 416 determines if the document is a color document or a monochromatic document in accordance with the image data generated by the scanner section 11. For example, the ACS determining portion 416 determines, in accordance with values of R, G, B in each pixel of image data, if each pixel is a color pixel or a monochromatic pixel.

Then, if the number of pixels determined as color pixels is greater than a predetermined number, the ACS determining portion 416 determines that the document is a color document. Any configuration of the ACS determining portion 416 may be adopted as long as it has an ability to determine a color image and a monochromatic image in accordance with image data generated by the scanner section 11.

The area separating portion 417 determines a kind of image of each area in image data outputted from the scanner section 11, and performs area separation. Herein, the area separation is to separate an image indicated by image data into a character area, a figure area (including frame lines of a table and a graph), a picture area, a background area, or the like. Then, the area separating portion 417 allows the information indicating each separated area into the HDD 21 as area information.

The area information, for example, correspondingly to each pixel of image data, indicates whether or not each pixel is a character area by indicating a pixel of a character area as “F”, a pixel of a picture area as “7”, and a pixel of a background area as “1”.

The area information reducing portion 418 omits the information indicating whether or not it is a character area corresponding to each pixel in area information by a predetermined rate, so as to reduce the information amount of area information generated by the area separating portion 417. In particular, the area information reducing portion 418 reduces the data amount of area information to be 25% by omitting the information indicating whether or not it is a character area corresponding to each pixel in area information, for example, every other in the main scanning direction and every other in the sub-scanning direction.

The character document determining portion 419 determines that the document is a character document, for example, in a case where a ratio of character area indicated by the area information, whose information amount is reduced by the area information reducing portion 418, in the image data is greater than a predetermined determination ratio (for example, 50%).

The compressing portion 420, in a case where the ACS determining portion 416 determines that the document is a monochromatic document, and the character document determining portion 419 determines that the document is a character document, compresses the image data generated by the scanner section 11 to be in a JBIG format or an MMR format, which are compression formats for a two-valued image, and stores the same into the HDD 21.

Further, the compressing portion 420, in a case where the ACS determining portion 416 determines that the document is a monochromatic document, and the character document determining portion 419 determines that the document is not a character document, compresses the image data generated by the scanner section 11 into a JPEG format, which is a compression format for a multi-valued image, and stores the same into the HDD 21.

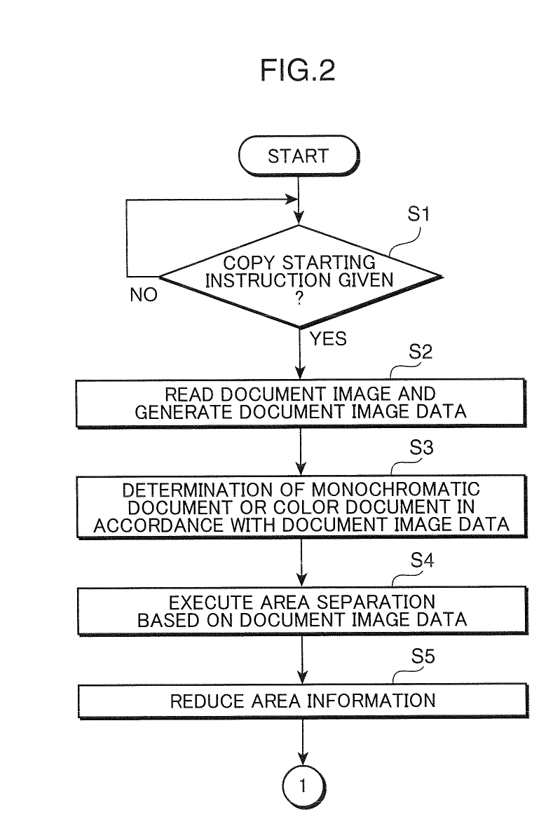

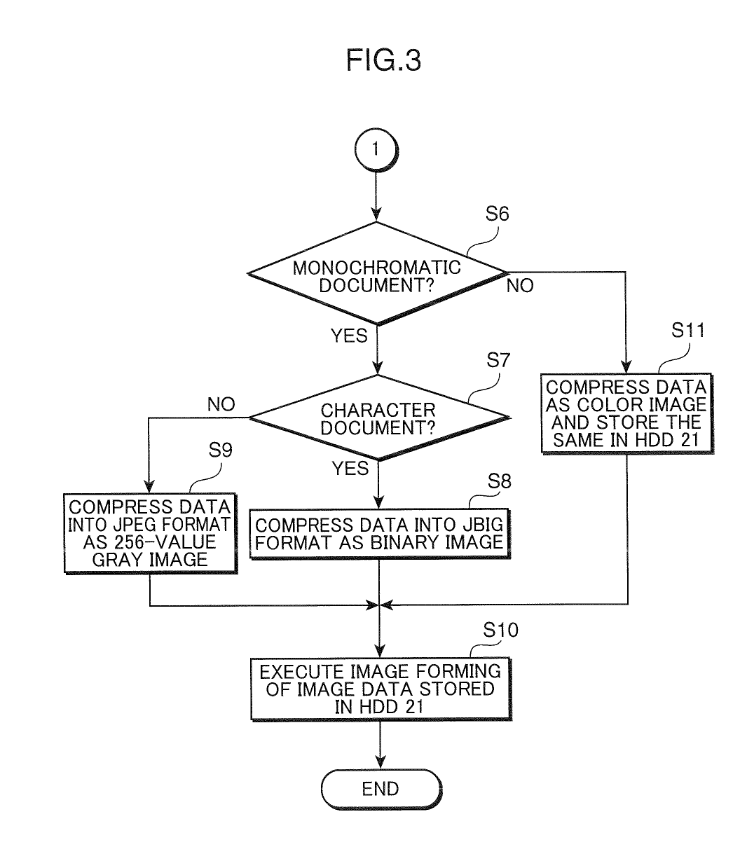

Next, an operation of the image forming apparatus 1 configured as described above will be described. FIGS. 2 and 3 are flowcharts showing an example of the operation of the image forming apparatus shown in FIG. 1. Firstly, for example, the operation panel section 51 is operated by a user to press, for example, the start key so that the operation panel section 51 receives a copy starting instruction (YES in step S1), the scanner section 11, in accordance with a control signal from the copy controller 415, reads a document image and generates image data of the document, and then the image data is stored in the HDD 21 (step S2).

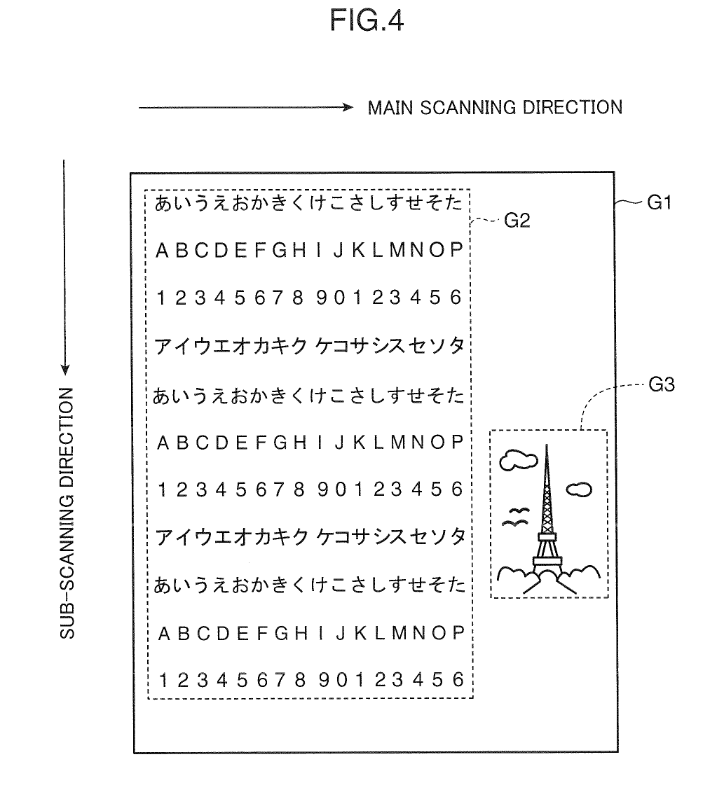

FIG. 4 shows an example of the document image read by the scanner section 11. The document image G1 shown in FIG. 4 includes a character image G2 and a picture image G3.

Next, in accordance with the image data of the document generated by the scanner section 11, the ACS determining portion 416 determines if the document is a color document or a monochromatic document (step S3).

Next, the area separating portion 417 determines a kind of image in each area in image data outputted from the scanner section 11 to execute the area separation. Then, the information indicating each area separated by the area separating portion 417 is stored as the area information into the HDD 21 (step S4).

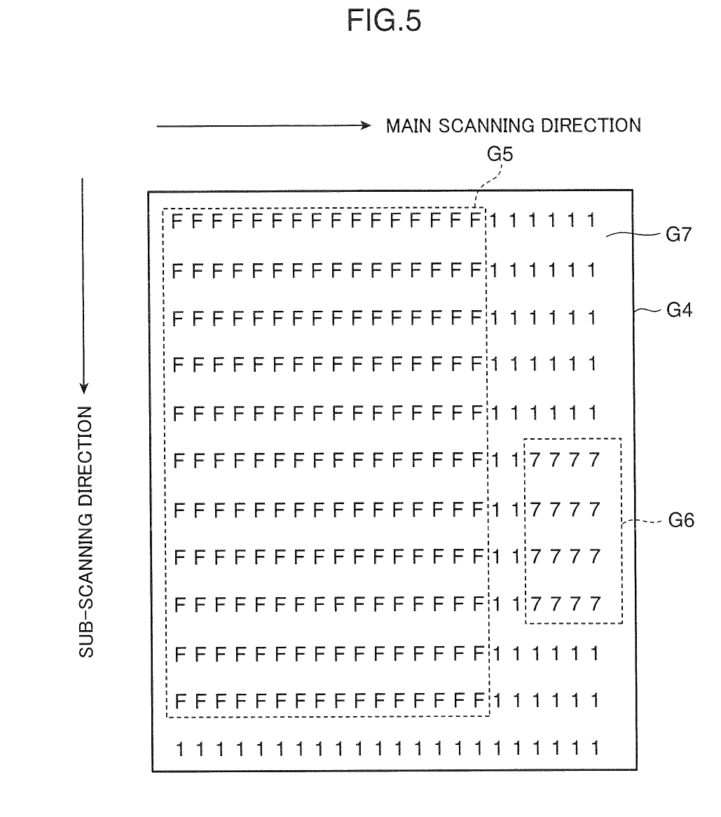

FIG. 5 shows an example of the area information generated by the area separating portion 417. Corresponding to each pixel of the document image G1, the area information G4 shown in FIG. 5 shows a pixel of character area G5 corresponding to the character image G2 as “F”, a pixel of the picture area G6 corresponding to the picture image G3 as “7”, and a pixel of the background area G7 corresponding to the background portion of the document image G1 as “1” to indicate if each pixel is character area or not.

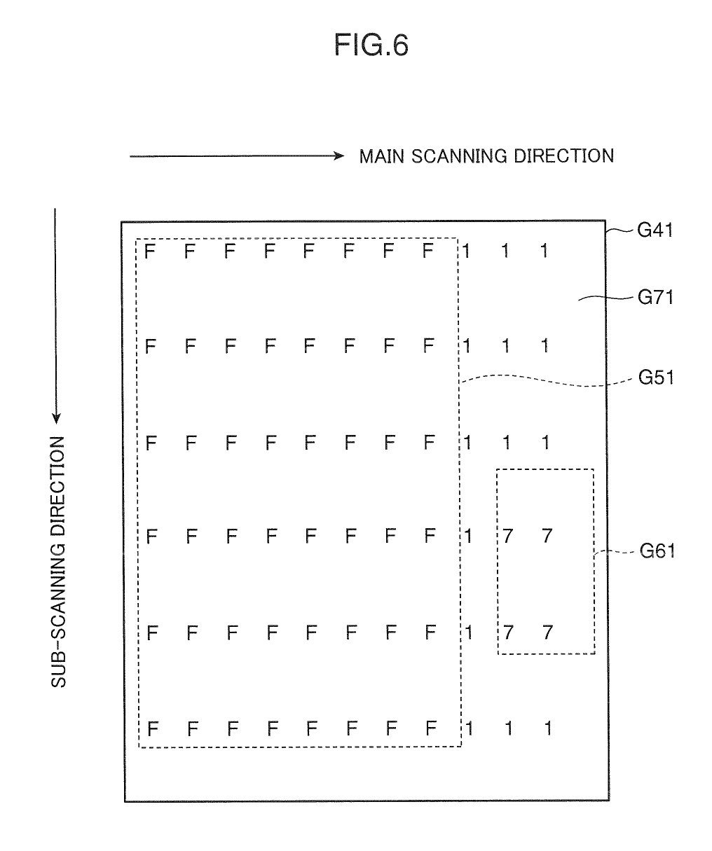

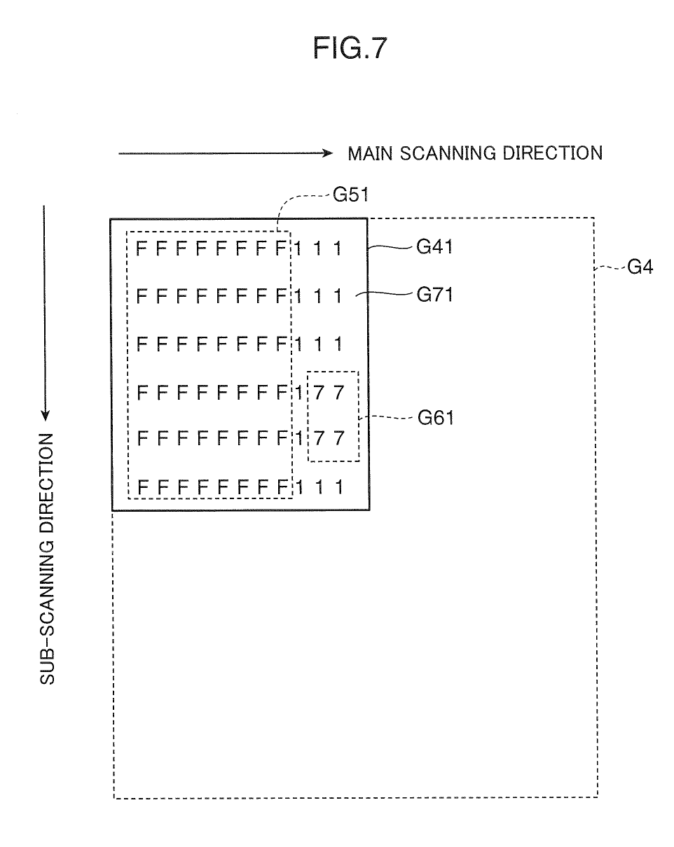

Next, the area information reducing portion 418 reduces the area information to reduce the information amount (step S5). FIGS. 6 and 7 show an operation of the area information reducing portion 418. In step S5, the area information reducing portion 418 reduces the information indicating if it is the character area corresponding to each pixel in the area information G4, for example, every other in the main scanning direction to be one-half and every other in the sub-scanning direction to be one-half. Accordingly, the area information G41 in which the data amount of the area information G4 is reduced to be one-fourth i.e. 25% is generated. In this case, the amount of data in the character area G5, the picture area G6, and the background area G7 are also becomes one-fourth, so as to become the character area G51, the picture area G61, and the background area G71, respectively.

Next, in a case where the document is a color image, in accordance with the determination result of the ACS determining portion 416 in step S3 (NO in step S6), the image data stored in the HDD 21 is compressed by the compressing portion 420 into a compression format suitable for a color image e.g. a color image of the JPEG format (step S11). As described above, in a case where the ACS determining portion 416 determines that the document is a color image, the image data stored in the HDD 21 in the compression format suitable for a color image is compressed. Accordingly, lowering in image quality can be reduced while reducing the amount of data of the image data. As long as the data amount of the image data can be reduced, the capacity of the HDD 21 and a semiconductor memory can be reduced, so that it becomes easy to reduce the cost for the storage device.

On the other hand, in step S6, in a case where a document is a monochromatic image (YES in step S6), the character document determining portion 419 confirms whether or not the document is a character document in accordance with the area information G41 whose data amount is reduced by the area information reducing portion 418 (step S7). In this case, the character document determining portion 419 confirms whether or not the document is a character document in accordance with the area information G41 whose data amount is reduced. Accordingly, since the amount of data processing is reduced, a determination processing time on whether or not it is the character document is shortened.

In a case where the document is a character document (YES in step S7), the compressing portion 420 compresses the image data stored in the HDD 21 into a compression format for a two-valued image, such as two-valued image of JBIG format, which can clearly realize a character image (step S8). Accordingly, since image data can be compressed into a compression format which is suitable for a character image, the data amount of image data can be reduced while reducing a possibility of lowering of the character image quality. If the data amount of image data can be reduced, the capacity of the HDD 21 and the semiconductor memory can be reduced. Therefore, the cost for the storage device can be reduced.

Further, in step S7, in a case where the document is a picture document, a halftone document, or the like, and it is not a character document (NO in step S7), the image data stored in the HDD 21 is compressed by the compressing portion 420 as 256-valued gray image data in, for example, a JPEG format which is a compression format for a multi-valued image (step S9). Accordingly, since image data can be compressed into a compression format which is suitable for a picture document and a halftone dot document, which are not character images, the data amount of image data can be reduced while reducing a possibility of lowering in image quality. If the data amount of image data can be reduced, the capacity of the HDD 21 and the semiconductor memory can be reduced. Accordingly, it becomes easy to reduce the cost of the storage devices.

If the images such as the picture document, the halftone dot document, or the like are compressed into a JBIG format or an MMR format, which are the compression formats for two-valued images, the data size becomes larger as compared to the case where the image is compressed in the JPEG format for multi-valued images. However, according to the image forming apparatus shown in FIG. 1, images such as the picture document and the halftone dot document are compressed in the JPEG format. Accordingly, the data amount of image data can be reduced efficiently.

Next, in accordance with image data in a compression format stored in the HDD 21 in steps S11, S8, S9, the printer section 30 forms an image onto a sheet (step S10). In this case, since the image data in the compression format stored in the HDD 21 is compressed in a compression format which is suitable for a kind of an image. Accordingly, quality of image to be formed on the sheet in accordance with the image data becomes unlikely to be reduced.

It should be understood that the image data in the compression format stored in the HDD 21 is not limited to the example of image forming with respect to a sheet. For example, in accordance with a controls signal from the scanner controller 412, the image data can be sent to an unillustrated terminal device from the network I/F section 71 through the network 711. In this case, since image data compressed in the compression format suitable for a kind of image is sent, the communication data amount can be reduced while reducing a possibility of lowering in image quality.

In summary, an image reading apparatus in accordance with an aspect of the present invention includes: a document reading section for reading an image from a document and generates image data indicating the read image; a determining section for determining that the document is a color document or a monochromatic document in accordance with the image data generated by the document reading section; an area separating portion for separating a character area in the image data generated by the document reading section, and generating area information indicating the separated character area; a character document determining portion for determining whether or not the document is a character document in accordance with the area information generated by the area separating portion; a compressing portion for compressing the image data generated by the document reading section into a first compression format which is a compression format for a two-valued image in a case where the determining section determines that the document is a monochromatic document and the character document determining portion determines that the document is a character document, the compressing portion compressing the image data generated by the document reading section into a second compression format for multiple-valued image in a case where the determining section determines that the document is a monochromatic document, and the character document determining portion determines that the document is not a character document; and a storage section for storing the image data compressed by the compressing portion.

According to this configuration, the document reading section reads an image from a document and generates image data indicating the read image. Further, the determining section determines if the document is a color document or a monochromatic document in accordance with the image data generated by the document reading section. Then, the area separating portion separates a character area in the image data generated by the document reading section, and generates area information indicating the separated character area. Further, the character document determining portion determines whether or not the document is a character document in accordance with the area information generated by the area separating portion. Further, in a case where the determining section determines that the document is a monochromatic document and the character document determining portion determines that the document is a character document, the compressing portion compresses the image data generated by the document reading section into the first compression format which is a compression format for a two-valued image. On the other hand, in a case where the determining section determines that the document is a monochromatic document, and the character document determining portion determines that the document is not a character document, the compressing portion compresses the image data generated by the document reading section into a second compression format for a multiple-valued image. Then, the storage section stores the image data compressed by the compressing portion.

Accordingly, determination that a document image is color or monochromatic is performed, and the image data can be compressed into a compression format which is suitable for a document image.

Further, it is preferable that, corresponding respectively to pixels of the image data generated by the document reading section, the area information includes information indicating whether or not each of the pixels belongs to character area, and the image reading apparatus further includes an area information reducing portion which omits the plurality of information indicating whether or not each pixel belongs to the character area at a predetermined ratio so as to reduce the information amount of area information generated by the area separating portion, and the character document determining portion determines whether or not the document is a character document in accordance with the area information whose information amount is reduced by the area information reducing portion.

According to this configuration, corresponding respectively to pixels of the image data generated by the document reading section, the area information includes information indicating whether or not each of the pixels belongs to character area. Further, the area information reducing portion omits the plurality of information indicating whether or not each pixel belongs to the character area at a predetermined ratio so as to reduce the information amount of area information generated by the area separating portion. Accordingly, the information amount of area information is reduced while maintaining a ratio of each area in the area information. Then, the character document determining portion determines whether or not the document is a character document in accordance with area information whose information amount is reduced by the area information reducing portion. In this case, since the information amount of area information is reduced while maintaining a ratio of each area in the area information, it can be determined whether or not the document is a character document while reducing the amount of data processing necessary for determining whether or not the document is a character document.

Further, it is preferable that the area information reducing portion takes off the plurality of information indicating whether or not each pixel belongs to the character area every other in the main scanning direction and every other in the sub-scanning direction.

According to this configuration, the information indicating whether or not each pixel belongs to the character area reduced by the area information reducing portion to be one-half in the main scanning direction and one-half in the sub-scanning direction, so that the amount of information is reduced to be one-fourth. Further, the area information reducing portion omits the information indicating whether or not each pixel belongs to character area every other in the main scanning direction and every other in the sub-scanning direction to reduce the amount of information to be one-fourth. Accordingly, it becomes not necessary to calculate a ratio of omitting data, so that the area information reducing portion can be realized with a simple configuration.

Further, it is preferable that the character document determining portion determines that the document is a character document in a case where a ratio of character area indicated by area information whose information amount is reduced by the area information reducing portion is greater than a predetermined determination ratio in the image data.

According to this configuration, the character document determining portion determines that the document is a character document in a case where a ratio of character area indicated by area information whose information amount is reduced by the area information reducing portion is greater than a predetermined determination ratio in the image data. In this case, even in a case where the document includes character area and areas other than the character in a mixed manner, a document in which a ratio of character area is large can be determined as a character document.

Further, it is preferable that the first compression format is a JBIG format.

According to this configuration, in a case where the document is a monochromatic character document, the image data is compressed into a JBIG format which is suitable for the monochromatic character document. Accordingly, efficiency in data compression can be improved while suppressing lowering in image quality.

Further, the first compression format may be an MMR format.

According to this configuration, in a case where a document is a monochromatic character document, the image data is compressed into an MMR format which is a compression format suitable for a monochromatic character document. Accordingly, efficiency in data compression can be improved while suppressing lowering in image quality.

Further, it is preferable that the second compression format is a JPEG format.

According to this configuration, in a case where a document is a monochromatic document and is not a character document, the image data is compressed into the JPEG format which is a compression format suitable for a picture and a halftone dot image. Accordingly, efficiency in data compression can be improved while suppressing lowering in image quality.

Further, it is preferable that the character document determining portion determines that the document is a character document in a case where a ratio of character area indicated by area information whose information amount is reduced by the area information reducing portion is greater than a predetermined determination ratio in the image data, and the first compression format is a JBIG format, and the second compression format is a JPEG format.

According to this configuration, the area information reducing portion omits the information indicating whether or not each pixel belongs to character area alternately in the main scanning direction and alternately in the sub-scanning direction, so that the amount of information to be one-fourth. Accordingly, it is not necessary to calculate a rate of omitting data. As a result, the area information reducing portion can be realized with a simple configuration. Further, in a case where the document is a monochromatic character document, the image data is compressed into a JBIG format which is a compression format suitable for the monochromatic character document. In a case where the document is a monochromatic document and is not a character document, the image data is compressed into the JPEG format which is a compression format suitable for pictures and halftone dot images. Accordingly, efficiency in data compression can be improved while suppressing lowering in image quality.

Further, it is preferable that the image reading apparatus further includes a network interface for performing transmission of data with respect to a terminal device connected via a network, and the network interface transmits the image data compressed and stored in the storage section to the terminal device.

According to this configuration, image data compressed in a compression format which is suitable for a kind of images transmitted to a terminal device connected through a network. Accordingly, the amount of communication data can be reduced while reducing a possibility of lowering in image quality.

Further, an image forming apparatus in accordance with an aspect of the present invention includes: the above-described image reading apparatus and an image forming section for forming an image onto a sheet in accordance with the compressed image data stored in the storage section.

According to this configuration, in the image forming apparatus, the determination that the document image is color or monochromatic is performed, and the image data for use in the image forming can be compressed in a compression format which is suitable for the document image. Accordingly, it becomes easy to reduce the capacity of the storage section. This application is based on Japanese Patent application serial No. 2007-270211 filed in Japan Patent Office on Oct. 17, 2007, the contents of which are hereby incorporated by reference.

Although the present invention has been fully described by way of example with reference to the accompanying drawings, it is to be understood that various changes and modifications will be apparent to those skilled in the art. Therefore, unless otherwise such changes and modifications depart from the scope of the present invention hereinafter defined, they should be construed as being included therein.

What is claimed is:

1. An image reading apparatus, comprising:
a document reading section for reading an image from a document and generating image data indicating the read image;
a determining section for determining that the document is a color document or a monochromatic document in accordance with the image data generated by the document reading section;
an area separating portion for separating a character area in the image data generated by the document reading section, and generating area information indicating the separated character area;
a character document determining portion for determining whether or not the document is a character document in accordance with the area information generated by the area separating portion;
a compressing portion for compressing the image data generated by the document reading section into a first compression format which is a compression format for a two-valued image in a case where the determining section determines that the document is a monochromatic document and the character document determining portion determines that the document is a character document, the compressing portion compressing the image data generated by the document reading section into a second compression format for multiple-valued image in a case where the determining section determines that the document is a monochromatic document, and the character document determining portion determines that the document is not a character document; and
a storage section for storing the image data compressed by the compressing portion.

2. The image reading apparatus according to claim 1, wherein
corresponding respectively to pixels of the image data generated by the document reading section, the area information includes information indicating whether or not each of the pixels belongs to character area, and
the image reading apparatus further comprising: an area information reducing portion which omits the plurality of information indicating whether or not each pixel belongs to the character area at a predetermined ratio so as to reduce the information amount of the area information generated by the area separating portion, and
the character document determining portion determines whether or not the document is a character document in accordance with the area information whose information amount is reduced by the area information reducing portion.

3. The image reading apparatus according to claim 2, wherein the area information reducing portion takes off the plurality of information indicating whether or not each pixel belongs to the character area every other in the main scanning direction of corresponding pixels and every other in the sub-scanning direction.

4. The image reading apparatus according to claim 2, wherein the character document determining portion determines that the document is a character document in a case where a ratio of character area indicated by area information whose information amount is reduced by the area information reducing portion is greater than a predetermined determination ratio in the image data.

5. The image reading apparatus according to claim 1, wherein the first compression format is a JBIG format.

6. The image reading apparatus according to claim 1, wherein the first compression format is an MMR format.

7. The image reading apparatus according to claim 1, wherein the second compression format is a JPEG format.

8. The image reading apparatus according to claim 3, wherein the character document determining portion determines that the document is a character document in a case where a ratio of character area indicated by area information whose information amount is reduced by the area information reducing portion is greater than a predetermined determination ratio in the image data, and
the first compression format is a JBIG format, and
the second compression format is a JPEG format.

9. The image reading apparatus according to claim 1, further comprising:
a network interface for performing transmission of data with respect to a terminal device connected via a network, wherein
the network interface transmits the image data compressed and stored in the storage section to the terminal device.

10. An image forming apparatus, comprising:
the image reading apparatus according to claim 1; and
an image forming section for forming an image onto a sheet in accordance with the compressed image data stored in the storage section.
